(19) United States
(12) Patent Application Publication
(10) Pub. No.: US 2014/0050471 A1
(43) Pub. Date: Feb. 20, 2014

(54) Apparatus And Method For Providing Protection In A Passive Optical Network

(71) Applicant: Pietro Arturo Bernasconi, Aberdeen, NJ (US)

(72) Inventor: Pietro Arturo Bernasconi, Aberdeen, NJ (US)

(73) Assignee: Alcatel-Lucent USA Inc., Murray Hill, NJ (US)

(21) Appl. No.: 13/586,302

(22) Filed: Aug. 15, 2012

(51) Int. Cl. H04B 10/20

(52) U.S. Cl. 398/2

(57) ABSTRACT

A manner of protecting communications in a PON (passive optical network). A switch array is provided in a CO (central office) and placed in communication with a number of primary OLTs, which each can thereby communicate with a respective feeder fiber when the associated switch of the switch array is in a first state. When the switch is placed in a second state, the feeder fiber instead communicates with a protection OLT. In some embodiments each switch communicates with the OLT more or less directly, while in others the protection OLT is in communication with a first switch of the switch array and the others communicate with the OLT via the first switch and possibly other intervening switches. The switches of the switch array may also be connected to redundant feeder fibers for additional protection. A system controller may be used to detect the need for protection and to control switch states accordingly to provide it.

### CROSS-REFERENCE TO RELATED APPLICATIONS

The present disclosure is related to U.S. patent application Ser. No. 13/293,369, entitled Apparatus and Method for Providing Protection in a Passive Optical Network and filed on 10 Nov. 2011; and to U.S. patent application Ser. No. 13/033,379, entitled Low-Energy Optical Network Architecture and filed on 23 Feb. 2011, the entire contents of which applications are incorporated by reference herein.

### TECHNICAL FIELD

The present invention relates generally to the field of communications networks, and, more particularly, to apparatus and method for efficiently providing communication protection for a communications network such as a PON, GPON, EPON, XGPON or 10GEPON.

### BACKGROUND

The following abbreviations are herewith defined, at least some of which are referred to within the following description of the state-of-the-art and the present invention.

### CO Central Office

### EPON Ethernet PON

### GPON Gigabit PON

### IEEE Institute of Electrical and Electronics Engineers

### ITU International Telecommunication Union

### NGPON Next Generation PON

### ODN Optical Distribution Network

### OLT Optical Line Terminal

### ONT Optical Network Terminal

### ONU Optical Network Unit

### PIC Photonic Integrated Circuit

### PLC Planar Lightwave Circuit

### PON Passive Optical Network

### SOA Semiconductor Optical Amplifier

### VOA Variable Optical Attenuator

Note that the techniques or schemes described herein as existing or possible are presented as background for the present invention, but no admission is made thereby that these techniques and schemes were heretofore commercialized or known to others besides the inventors.

Operators of large communications networks, some of whom are referred to as carriers or service providers, maintain widespread networks to handle many kinds of traffic, for example Internet access or television programming. Telephone service may also be provided. These large networks are traditionally divided into the core network, metropolitan network, and the access network or networks. The core networks carry large amounts of digitally-encoded information over high-capacity cables or other transmission media and provide the backbone of the transmission systems. Metropolitan networks, or metro networks, cover the distribution and traffic aggregation within a more limited geographical area and typically act as intermediate step between the core and the access networks that are used by individual subscribers or other customers such as institutions or businesses.

A PON (passive optical network) is one type of access network. PONs use fiber optic cables to send light-energy signals carrying encoded information from the core network to the premises of a subscriber or group of subscribers, such as a home, apartment building or small business. The PON may in some cases reach only to a point accessible to the customer (on or off their premises) by other means such as a copper wire or wireless connection, although FTTH (fiber to the home) is becoming common. Wherever the demarcation point, however, the subscriber may connect a single device to the PON or, more commonly, have a network of their own that enables many devices to communicate with the network via the PON.

PONs use standard multiplexing schemes to permit communications to and from many different subscribers to be carried over one or a small number of cables, at least until the point where the communication channel must diverge to reach each individual subscriber premises. The transmission capacity of the PON is much lower than what is available in the core or metro network, although it remains adequate to service a great number of subscribers.

PON standards have undergone a series of evolutions, for example APON, BPON, and EPON, GPON (gigabit PON), the latter two being currently in widespread use. Standards being developed include 10GEPON, xPON, and xGPON. Broadly speaking, the present invention is applicable and useful in all or most of the foreseeable evolutions of the basic PON concept.

As the amount of data, services and service qualities increase, a need exists to provide protection for the communications being handled by the PON. In the sense used here, “protection” refers to a practice of ensuring that an alternate communication path is available, where possible, in the event that a primary communication path (or portion thereof) is lost or degrades to an unacceptable level of quality. It is highly desirable, however, that this protection be provided as efficiently and cost-effectively as possible so that it may be practically and cost-effectively implemented, even in existing systems. These needs and other needs are addressed by the present invention.

### SUMMARY

The present invention is directed to a manner of protecting communications in a PON (passive optical network). In one aspect, the present invention is a protection system for a PON including a plurality of switches, each switch of the plurality of switches having at least a first state and a second state and comprising a first port for communicating with a primary OLT (optical line terminal) and a second port for communicating via a feeder fiber, wherein the first port is placed in communication with the second port when a switch is in a first state. The switches are in a preferred embodiment 2×2 optical switches formed on a single optical ship such as a PLC (planar lightwave circuit). In some embodiments, each switch of the plurality of switches comprises a third port for communicating with a protection OLT wherein the third port is placed in communication with the second port when a switch is in a second state.

Some embodiments of the invention also include a plurality of primary OLTs and at least one protection OLT. Note that in a preferred embodiment, a protection switch array will be associated with a single protection OLT. In some cases at least one switch of the array of switches communicates with the at least one protection OLT via at least one other switch of the plurality of switches. In such an embodiment, the at least one other switch comprises a fourth port in communication with the third port of the at least one switch. In other embodiments, the communication channel between the third port of each switch of the plurality of switches and protection OLT does not include another switch of the plurality of switches. That is, in the latter case each switch of the switch array may be connected to the protection OLT.

In some embodiments, feeder fiber protection is also provided. Where that is the case, each switch of the plurality of switches further includes a fourth port for communicating via a second feeder fiber wherein the first port is placed in communication with the fourth port when a switch is in the second state. This embodiment may also include a plurality of first feeder fibers, each first feeder fiber connected to a second port of a respective switch of the plurality of switches and a plurality of second feeder fibers, each second feeder fiber connected to a fourth port of a respective switch of the plurality of switches.

In some embodiments with at least one protection OLT comprises an optical transmitter and means for distributing light from the transmitter to a plurality of communication channels, each communication channel associated with a switch of the plurality of switches. The means for distributing may be, for example, a power splitter or an wavelength selective element like for example an arrayed waveguide grating (AWG). Note that all these elements may, in some embodiments, be conveniently integrated on a same optical chip. In some embodiments an optical amplifier may also be present for amplifying the signal from the transmitted preferably before it is distributed. The communication channels may include a respective attenuator, such as a VOA, for selectively blocking transmissions along the various communication channels. The protection OLT may also include an optical receiver and, if so, the communication channels may also include filters such as dichroic filters or optical circulators for directing upstream transmissions to the receiver. In a preferred embodiment, the communications channels, including the VOAs and filters if present, are formed on the single optical chip with the switch array.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a simplified schematic diagram illustrating a typical PON in which an embodiment of the present invention may be implemented;

FIG. 2 is a simplified schematic diagram illustrating a protection switch array according to an embodiment of the present invention;

FIG. 3 is a simplified schematic diagram illustrating selected components of a PON according to an embodiment of the present invention;

FIG. 4 is a simplified schematic diagram illustrating a protection switch array according to another embodiment of the present invention;

FIG. 5 is a simplified schematic diagram illustrating selected components of a PON according to another embodiment of the present invention;

FIG. 6 is a simplified schematic diagram illustrating a protection switch array according to another embodiment of the present invention;

FIG. 7 is a simplified schematic diagram illustrating selected components of a PON according to another embodiment of the present invention;

FIG. 8 is a simplified schematic diagram illustrating selected components of an OLT according to an embodiment of the present invention;

FIG. 9 is a simplified schematic diagram illustrating selected components of an OLT according to another embodiment of the present invention;

FIG. 10 is a flow diagram illustrating a method of providing PON protection according to an embodiment of the present invention; and

FIG. 11 is a flow diagram illustrating a method of providing PON protection according to another embodiment of the present invention.

### DETAILED DESCRIPTION

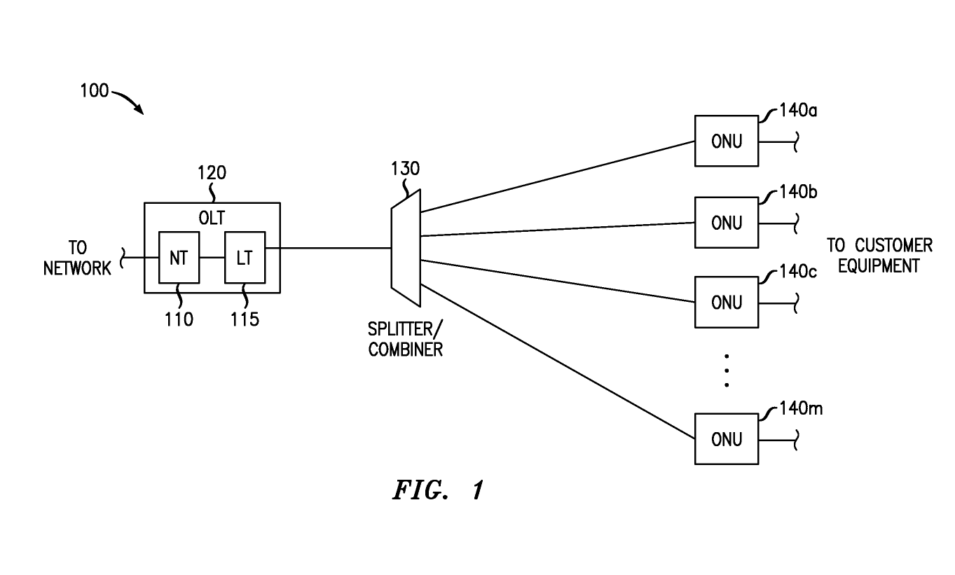

The present invention is directed at a manner of providing efficient communication protection for optical communications networks. As mentioned above, a PON typically provides a connection between a core network and individual subscribers. FIG. 1 is a simplified schematic diagram illustrating a typical PON 100 in which an embodiment of the present invention may be implemented. PON 100 extends from OLT 120 to the ONUs 140a through 140m. OLT 120 is typically located in the CO (central office) of a carrier or service provider and is connected to the metropolitan or core part of the carrier's network (not shown). Note that the PON 100 of FIG. 1 is simplified for convenience; in a typical implementation, there may be a large number of OLTs. Generally speaking, however, the layout depicted in FIG. 1 is representative across the network.

OLT 120, like each of the OLTs in a typical deployment, serves a number of ONUs, handling communication traffic both from the network in a downstream direction and from the individual ONUs in an upstream direction. Shown in FIG. 1 are ONUs 140a through 140m. In many cases the ONU is located at the subscriber's premises and is connected to a home gateway or router or similar equipment (not shown) owned or provided by the subscriber.

OLT 120 itself is also simplified for convenience. In FIG. 1 OLT 120 includes an LT (line terminal) module 115 and an NT (network terminal) module 110. Each of the modules may be implemented on a separate card or printed circuit board. The NT module 110 acts as an interface with the core network for upstream traffic and routes downstream traffic to the appropriate LT module or modules for transmission to subscribers. A single LT module 115 is depicted in FIG. 1. The LT module 115 interfaces with the subscriber lines. The communications between the NT module 110 and the LT module 115 are typically electronic signals, so the LT module 115 converts electrical signals to optical signals in the downstream direction and received optical signals into electrical signals in the upstream direction.

In the PON 100 of FIG. 1, a separate fiber optic cable is routed to each of the subscriber ONUs 140a through 140m. These separate fibers do not, however, extend all the way from the OLT 120. Instead the optical signals for ONUs 140a through 140m are transmitted to a power splitter/combiner 130. The splitter/combiner 130 divides the optical signal, which is then sent to each of the ONUs. Where the splitter/combiner 130 provides optical power splitting, the downstream signals are broadcast to all ONUs, which then independently extract the portion of data of interest. In case the splitter/combiner provides wavelength separation capability, different wavelength may be assigned and forwarded to different ONUs. Note that the two options may also coexist. Communications from the ONUs are usually sent according to a schedule determined by the OLT 120, and to directed splitter/combiner 130 for upstream transmission to LT module 115.

As might be expected, it is advantageous to place the splitter/combiner 130 relatively closer to the subscribers than to the CO to minimize the amount of fiber that is needed for distribution to the end user. The splitter/combiner 130 may, for example, reside (along with a number of other such devices) in an “outside plant” such as street cabinet. It should be noted in this regard that the illustration of FIG. 1 is not to scale and the splitter/combiner 130 is shown as centrally located only for clarity.

As mentioned above, in a typical deployment, there may be several, even a large number of OLTs each serving a number (which may vary) of ONUs in a fashion similar to that shown in FIG. 1. Note that for purposes of understanding the present invention, it does not matter whether each OLT is a separate component in the CO or simply separate LTs. If an OLT is for some reason down or removed from service, its respective ONUs are also affected. Embodiments of the present invention address this issue.

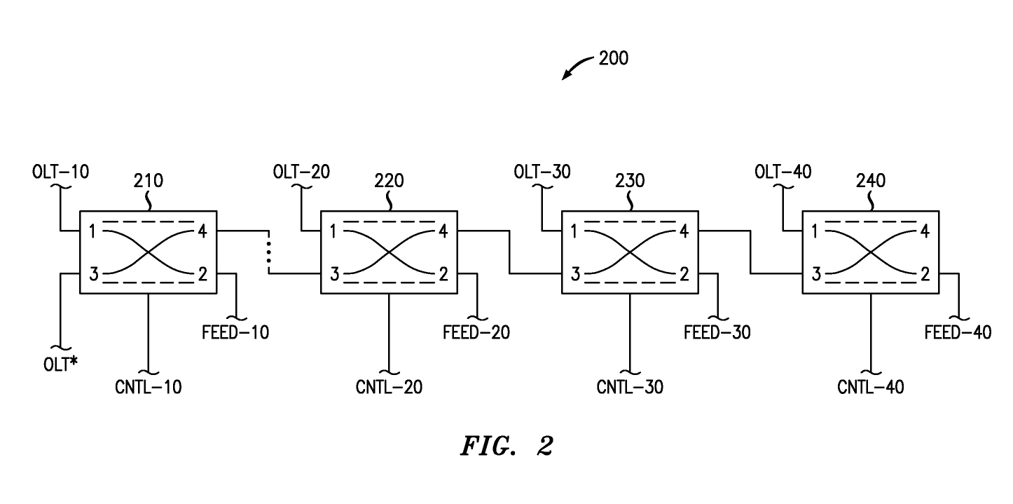

FIG. 2 is a simplified schematic diagram illustrating a protection switch array 200 according to an embodiment of the present invention. The switches of switch array 200 are, in this embodiment, each 2×2 optical switches, although some additional ports may be present in some implementations, and of course all of the switches do not have to be identical. In a preferred embodiment, the switches of switch array 200 are formed as a PIC on a single photonic chip. Other technologies may be used such as micro-electromechanical systems (MEMS), simple mechanical switches, or others.

In this embodiment, four switches (210, 220, 230, 240) are shown, though there may be any number as implied by the ellipsis between switch 210 and switch 220. Note that the physical layout shown in FIG. 2 is exemplary; other layouts are possible so long as the proper connections may be made. Each of the switches in this embodiment includes four ports, numbered 1 through 4 on each respective switch. For convenience in this description, the ports may sometimes be referred to by a hyphenated combination of switch and port numbers. For example, the ports of switch 210 may be referred to simply as ports 210-1, 210-2, 210-3, and 210-4.

The switching states of each switch are illustrated in FIG. 2 using solid and broken lines. In a first state, sometimes referred to as a cross state, ports 210-1 and 210-2 are in optical communication, as are ports 210-3 and 210-4. In a second, or bar state, ports 210-1 and 210-4 are in optical communication, as are ports 210-3 and 210-2. The ports and states used for these connections are exemplary, though of course it is important to be able to establish the connection paths recited in various embodiments of the invention. The cross states of the switches are respectively represented by solid and broken lines drawn between the ports. Switches achieving the same result in a different fashion may also be used.

In this embodiment, each switch 210, 220, 230, 240 is respectively connected to a control (CNTL) line CNTL-10, CNTL-20, CNTL-30, CNTL-40 that provides a switching current or other signal as necessary to control switching from one state to another. The switches of switch array 200 may be latching or non-latching and may default to either the bar state or the cross state, though in many implementations it may be preferred that the switches are able to maintain a connection between the primary OLT associated with a respective switch and a feeder line as a default condition even if there is no control signal present.

In the embodiment of FIG. 2, port 1 of switch 210 is for connecting with a primary OLT-10 (not shown in FIG. 2). In similar fashion, port 1 of switch 220 is for connecting with primary OLT-20, port 230-1 with OLT-30, and port 240-1 with OLT-40. If there are additional switches present (not shown), they would preferably be similarly connectable. In most cases there will be a switch present for each OLT in a given configuration, though in some arrays it may be desirable to form additional switches that could be put into service if necessary. Normally, each of the OLTs in a given configuration will be associated with a switch in the switch array 200. And while there may be more than one switch array in a given CO, it is of course not a requirement that all OLTs in the CO be protected according to the present invention.

The term “primary OLT” indicates an OLT that is being protected by the protection OLT. In this embodiment, port 3 of switch 210 is for connecting with the protection OLT (designated in FIG. 2 as OLT*). In most configurations there is expected to be one protection OLT* for each protection switch array, although this also may vary.

In the embodiment of FIG. 2, port 4 of switch 210 is in communication with port 3 of switch 220 (or to port 3 of a switch, if any, located between OLT 210 and OLT 220). As should be apparent, in the cross state ports 210-3 and 210-4 are in communication so connecting ports 210-4 and 220-3 means that switch 220 also communicates with the protection OLT* so long as switch 210 is in the cross state. In similar fashion, port 4 of switch 220 is connected with port 3 of switch 230 and port 4 of switch 230 is connected with port 3 of switch 240. Port 4 of switch 240 is not used in this embodiment, but could be connected to another switch (not shown) if necessary. Port 240-4 could also be placed in communication with another device, for example a diagnostic circuit or piece of equipment, or with multiple other devices by employing a power splitter or AWG (also not shown).

In the embodiment of FIG. 2 the remaining port of each switch in switch array 200, port 2 is connectable to a respective feeder fiber. Port 210-2 is for connecting to feeder fiber FEED-10, port 220-2 is for connecting to feeder fiber FEED-20, and ports 230-2 and 240-3 are for connecting to FEED-30 and FEED-40, respectively.

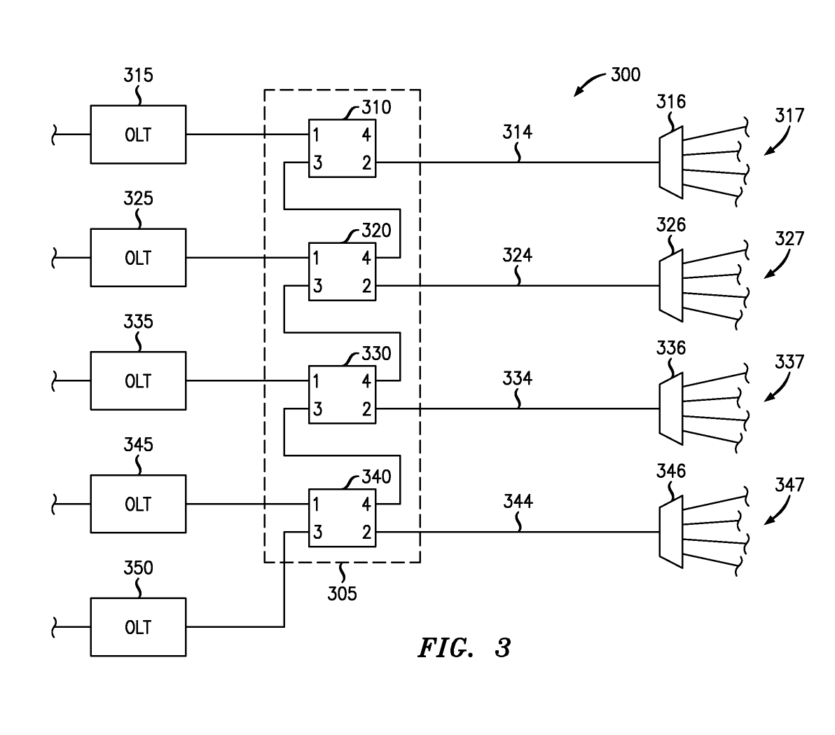

When switch array 200 of FIG. 2 is connected in the fashion contemplated above, it is expected that in normal operation the switches depicted in of protection switch array 200 will be in their cross state and each primary OLT is therefore connected to its respective feeder line (see, for example, FIG. 1). The presence of redundant OLT* provides protection for the primary OLTs when coupled with the use switch array 200. Should any primary OLT cease to function, either for planned maintenance or through an unplanned event, the state of the switch corresponding to that OLT may be changed. The second switch state, in FIG. 2 allows the redundant OLT* to be placed in communication with a feeder fiber associated with the failing primary OLT connected at port 2. Note that during the switching all other OLTs and their corresponding PON branches remain totally unaffected. Naturally, as the redundant OLT* takes the place of a primary OLT, communications with the metro or core network are re-directed appropriately. An application of a switch array according to and embodiment of the present invention is provided in FIG. 3.

FIG. 3 is a simplified schematic diagram illustrating selected components of a PON 300 according to an embodiment of the present invention. In this embodiment, a switch array 305 is employed to provide protection for the network. Switch array 305 is similar though not necessarily identical to the switch array 200 illustrated in FIG. 2 and described above.

In the embodiment of FIG. 3, PON 300 includes four OLTs 315, 325, 335, 345 although in an actual deployment there may be any number, subject to practical limitations. Each OLT 315, 325, 335, 345 is in communication with a core network (not shown) and serves a number of ONUs (also not shown) via a respective feeder fiber 314, 324, 334, 344. Each feeder fiber is in turn connected to a respective splitter/combiner 316, 326, 336, 346, and each of the splitters communicates with its associated ONUs (not shown) via a set of access fibers, here collectively referred to as 317, 327, 337, and 347.

In accordance with this embodiment of the present invention, each primary OLT 315, 325, 335, 345 is connected to the first port of a respective switch 310, 320, 330, 340 of protection switch array 305. As mentioned above, it is not a requirement that there is the same number of switches as OLTs, but in most implementations this is expected to be the case. A protection (redundant) OLT 350 is connected to the third port of switch 340.

In the embodiment of FIG. 2, when switch 340 is in a first state the OLT 345 is in communication with feeder fiber 344, which is connected to port 2 of switch 340. In this state, protection OLT 350 is in communication with switch 330 via the connection between ports 340-4 and 330-3, although there may be no communications to or from protection OLT presently occurring. In what will generally be considered normal operation, OLT 345 serves the ONUs (not shown) associate with access fibers 347.

In this embodiment, if it is determined that primary OLT 340 is unable to satisfactorily fulfill this function the state of switch 340 is changed to a second state. (The control line for controlling the state of a switch is illustrated in FIG. 2, but not shown in FIG. 3.) When switch 340 is in the second state, ports 3 and 2 are connected and the feeder fiber 344 is placed in communication with protection OLT 350. In this configuration, OLT 350 may now serve the subscriber devices associated with access fibers 347, presuming the appropriate back-plane traffic rerouting is performed.

As used herein, “back-plane traffic rerouting” is a general term that describes modifying whatever process or apparatus that is used to route traffic to and from OLT 345 on the core network side is modified to permit, usually temporarily, such traffic to instead be sent to and received from protection OLT 350.

Returning to the embodiment of FIG. 3, a similar change in state instead may be effected for any one of switches 310, 320, or 330 as well. For example, changing the state of switch 320 to a second state places ports 3 and 2 of switch 320 in communication, thereby placing protection OLT 350 in communication with feeder fiber 324. This of course presumes that switches 330 and 340 remain in the first state such that ports 340-3 and 340-4, and 330-3 and 330-4 remain in communication and establish the connection between OLT 350 and port 3 of switch 320. It is also noted that when switch 320 is in the second (protection) state, switch 310 cannot effect a connection between protection OLT 350 and feeder fiber 314 even by switching states.

Of course, when the need for protection of OLT 325 traffic is alleviated, for example by making necessary repairs, then switch 320 is placed back into the first state, and the connection restored between OLT 325 and feeder fiber 324. When that occurs the switch 310 may be placed in a second state connecting ports 310-3 and 310-2 and providing a connection between OLT 350 and feeder fiber 314, presuming the other switches of array 305 are in their primary or first state.

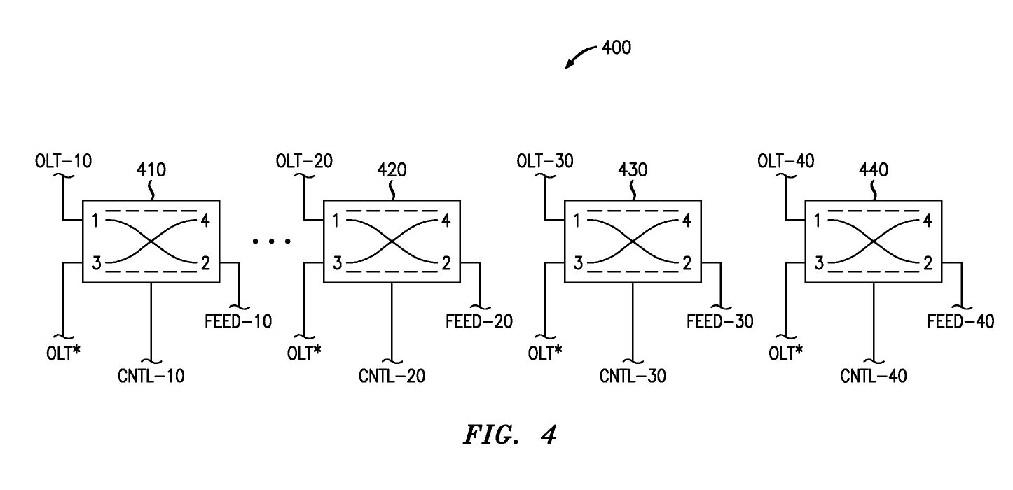

In other words, in the embodiment of FIG. 3, protection using OLT 350 may only be made for one primary OLT at a time. In many implementations this will be sufficient as the need for simultaneous protection of multiple OLTs may be unusual and may not always be justified economically. Additional protection may obtain, however, by connecting each switch in the protection switch array to the protection OLT, as will be illustrated in FIG. 4.

FIG. 4 is a simplified schematic diagram illustrating a protection switch array 400 according to another embodiment of the present invention. Initially, it is noted that this switch array is similar though not identical to the switch array 200 of FIG. 2. In FIG. 4, four switches are shown (410, 420, 430, 440), although the switch array 400 may have any number as indicated by the ellipsis between switch 410 and switch 420.

In the embodiment of FIG. 4, each of the switches 410, 420, 430, and 440 includes a third port for connecting to a protection (or redundant) OLT*. The connection may be direct or via other components, but it does not go through any other switch of switch array 400. For this reason no connection is anticipated for the fourth port on any of the switches unless it is for diagnostic equipment or another ancillary function. As with switch array 200 of FIG. 2, a first port of each switch in switch array 400 is for connecting to a respective OLT-10, OLT-20, OLT-30, OLT-40, and a second port of each switch is for connecting to a respective feeder fiber FEED-10, FEED-20, FEED-30, FEED-40. When a switch, for example switch 420, is in a first state, again in this embodiment a cross state, ports 1 and 2 are placed in communication. When switch 420 is placed in a second state, in this embodiment a bar state, ports 3 and 2 are placed in communication with each other. Each switch has a respective control line CNTL-10, CNTL-20, CNTL-30, CNTL-40, which may be used to change the switch state. Note that in this embodiment, no connections between switches are configured. Port 4 of each switch is therefore not used for this purpose.

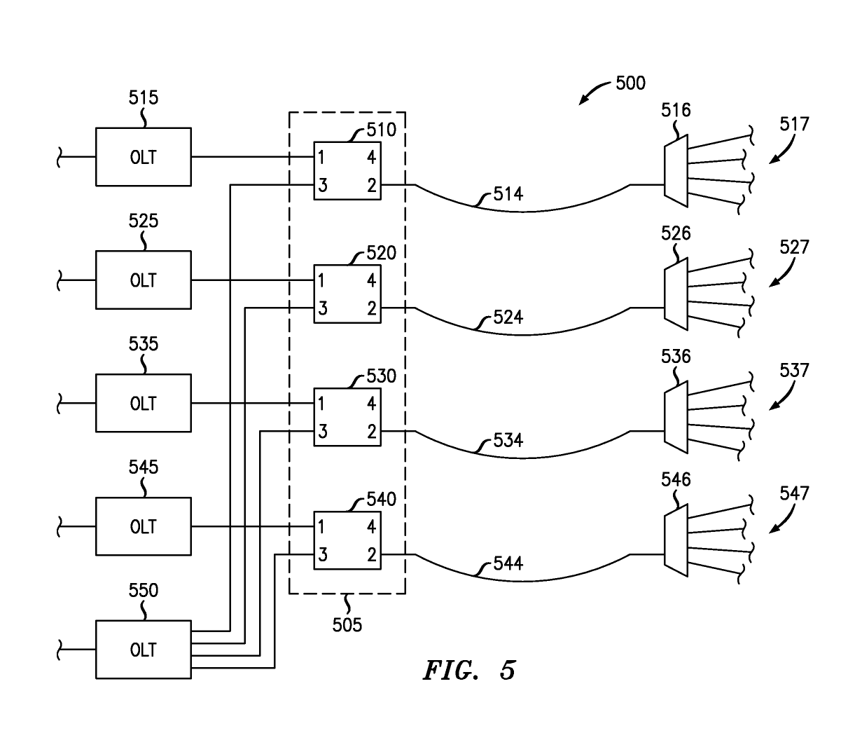

FIG. 5 is a simplified schematic diagram illustrating selected components of a PON 500 according to another embodiment of the present invention. PON 500 employs a switch array 505, which is configured similarly to the switch array 400 shown in FIG. 4. PON 500 also includes four primary OLTs 515, 525, 535, 545 although again there may be any number within practical limitations. Each of the OLTs 515, 520, 530, 540 is connected to port 1 of a respective switch 510, 520, 530, 540 of switch array 505.

In the embodiment of FIG. 2, each of the four switches of switch array 505 is connected to a respective feeder fiber 514, 524, 534, 544 at a second port. The feeder fibers are in turn connected to a respective splitter/combiner 516, 526, 536, 546, which distributes the light propagating downstream to the access fibers 517, 527, 537, 548 and collects the upstream traffic for propagation along a respective feeder fiber 514, 524, 534, 544.

In this embodiment, when a switch is in a first state its ports 1 and 2 are in communication, which in this configuration places a primary OLT in communication with its associated feeder fiber. Protection OLT 550 is connected to a respective third port on each switch 510, 520, 530, 540 so that when a switch of switch array 505 is placed in a second state, protection OLT 550 is placed in communication with the feeder fiber associated with the switch. Note that in this embodiment, the state of one switch does not affect the ability of any other switch to effect a connection between OLT 550 and its associated feeder fiber. In this manner protection OLT 550 can provide protection for more than one of the OLTs 515, 525, 535, 545, although some accommodation will have to be made if two or more of the switches 510, 520, 530, 540 are placed in the second, protection state, for example using a multiplexing technique such as TDM (time division multiplexing), to separate traffic intended for one feeder fiber as opposed to another. This will be described in more detail below.

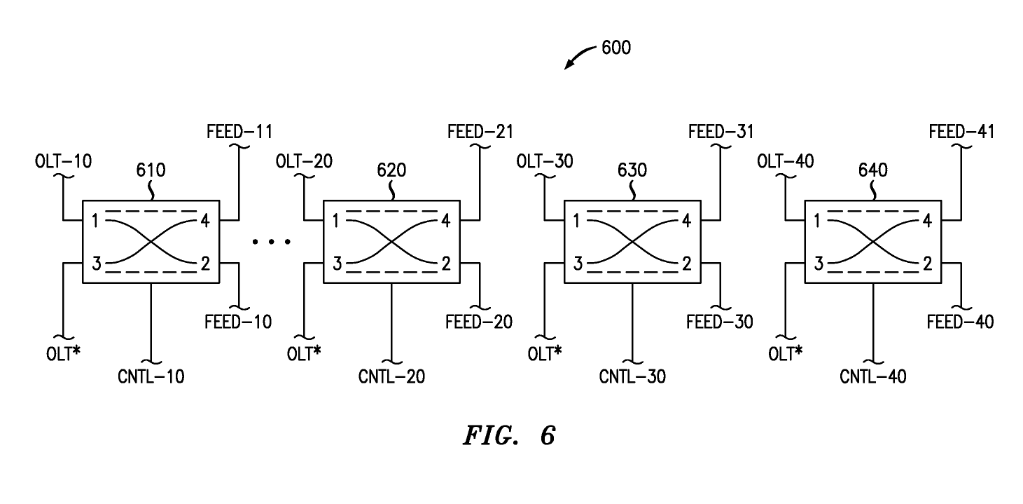

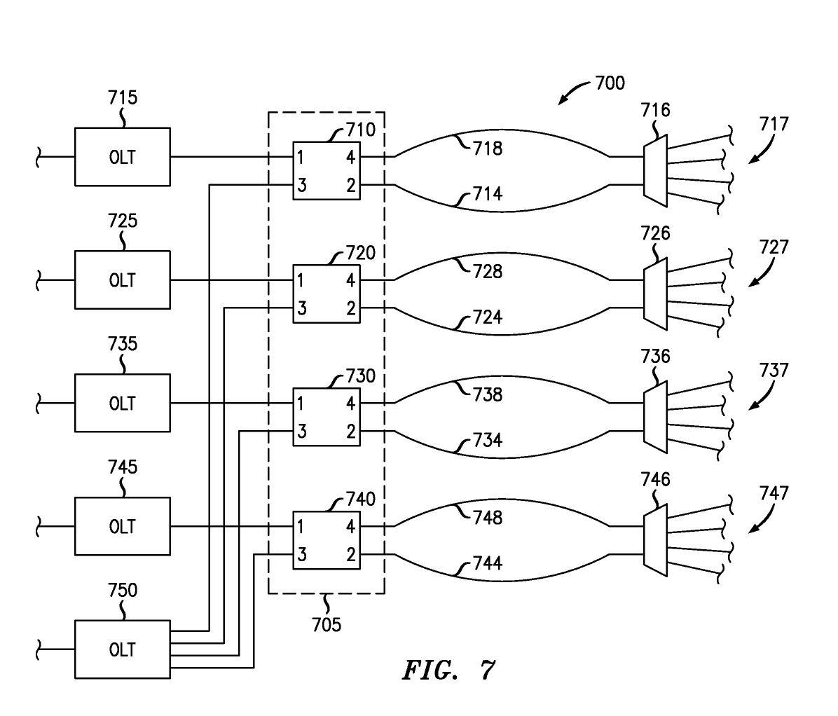

It is noted that in the embodiment of FIG. 5 protection may be provided for each OLT 515, 525, 535, 545, and even more than one of them at the same time. Additional constraints may arise since the same resources may have to be shared among multiple PON branches and the full capacity may not be always supported. Partial services may be provided but a complete service interruption can be avoided. There is not additional ability however, to protect the communication link along the feeder fiber between a switch 510, 520, 530, 540 and its respective splitter/combiner 516, 526, 536, 546. Other embodiments are able to provide feeder fiber protection as well, for example the embodiment illustrated in FIGS. 6 and 7.

FIG. 6 is a simplified schematic diagram illustrating a protection switch array 600 according to another embodiment of the present invention. In the embodiment, of FIG. 6, each switch 610, 620, 630, 640 of switch array 600 includes a first port for connecting to a respective primary OLT-10, OLT-20, OLT-30, OLT-40 (not shown in FIG. 6) and a second port for connecting to a respective feeder fiber FEED-10, FEED-20, FEED-30 FEED-40 (also not shown). A third port is provided on each switch of switch array 600 for connecting to a redundant (protection) OLT*. In accordance with this embodiment, a fourth port of each switch 610, 620, 630, 640 is provided for attachment to a respective feeder fiber FEED-11, FEED-21, FEED-31 FEED-41 (see FIG. 7).

In this embodiment, a respective control line CNTL-10, CNTL-20, CNTL-30, CNTL-40 is attached to switches 610, 620, 630, 640 for providing a control signal to change the switch state. In this embodiment, when a switch is placed in a first, cross state, ports 1 and 2 are placed in communication with each other, as are ports 3 and 4. When a switch is placed in a second, bar state, communication is established between ports 3 and 2, and also between ports 1 and 4. The advantage of this configuration will be described in reference to FIG. 7.

FIG. 7 is a simplified schematic diagram illustrating selected components of a PON 700 according to another embodiment of the present invention. PON 700 includes a switch array 705 having 2×2 switches 710, 720, 730, 740. A first port on each switch is connected to a respective primary OLT 715, 725, 735, 745, and a second port on each switch is connected to a respective first feeder fiber 714, 724, 734, 744. In this embodiment, a fourth port on each switch is connected to a respective redundant or second feeder fiber 718, 728, 738, 748. The feeder fibers connected to a given switch of switch array 600 are also connected to the same splitter/combiner.

In the embodiment of FIG. 7, PON 700 is shown to have fours splitters 716, 726, 736, 746. Splitter 716, for example, connected to OLT 715 via switch 710 and feeder fibers 714 and 718. Feeder fibers 714 and 718 may be referred to as a first fiber and a second fiber, or as a primary fiber and redundant fiber, but in most implementations they will be of similar capability and construction. They may, however, be routed separately so that, for example, the inadvertent damaging of one of them does not necessarily affect the operation of the other. Each splitter 716, 726, 736, 746 distributes light propagating downstream on either of fibers 714 or 718 to a number of respective access fibers, referred to here as 717, 727, 737, and 747. The access fibers are connected or connectable to ONUs (not shown) or similar devices. Upstream traffic propagating along any of the access fibers is collected by the splitter 716, 726, 736, 746 for transmission along the connected feeder fibers. The splitter/combiners may be easily designated as 2:4 splitters (or 2:N to represent that more or fewer access fibers may be present in a given implementation) and essentially provide the same functionality as the 1:N counterparts.

In the embodiment of FIG. 7, a redundant or protection OLT 750 is connected to a third port of each switch 710, 720, 730, 740 of switch array 700. In this fashion protection is provided for each of the OLTs of PON 700 and for the feeder fibers as well. As an example, in a first state switch 710 places ports 710-1 and 710-2 in communication and, as a consequence, primary OLT 715 and feeder fiber 714. Should a failure be detected in feeder fiber 714, switch 710 may be placed in a second state in which ports 710-1 and 710-4 are in communication. In this state, OLT 715 and protection feeder fiber 718 are placed in communication. The upstream and downstream communication between OLT 715 and splitter 716 is unaffected, except for any necessary procedures associated with the switched connection (if the lengths of the two feeder fibers are different, for example, a new ranging process may be needed).

When the necessary repairs are made, switch 710 may be placed in its first state and communication re-established between OLT 715 and feeder fiber 714. Again it is noted, however, that feeder fibers 714 and 718 are in most implementations more or less equivalent channels, and may carry the traffic load indefinitely.

In another scenario involving this embodiment, if primary OLT 725 fails, switch 720 may be placed in a second state where ports 720-3 and 720-2 are in communication. Protection OLT 750 may the assume responsibility for supporting access fibers 727 and the subscriber devices (not shown) to which they are attached. As should be apparent, however, if switch 720 remains in the first state, Protection OLT 750 may also provide this support via the feeder fiber 718. That is, protection of the feeder portion of the PON is still available.

As should also be apparent, in this embodiment only one of the protection OLT 750 and any primary OLT should be operating at a given time, since absent a line break they both remain in communication with a respective splitter/combiner. A protection OLT configuration for addressing this issue will now be described.

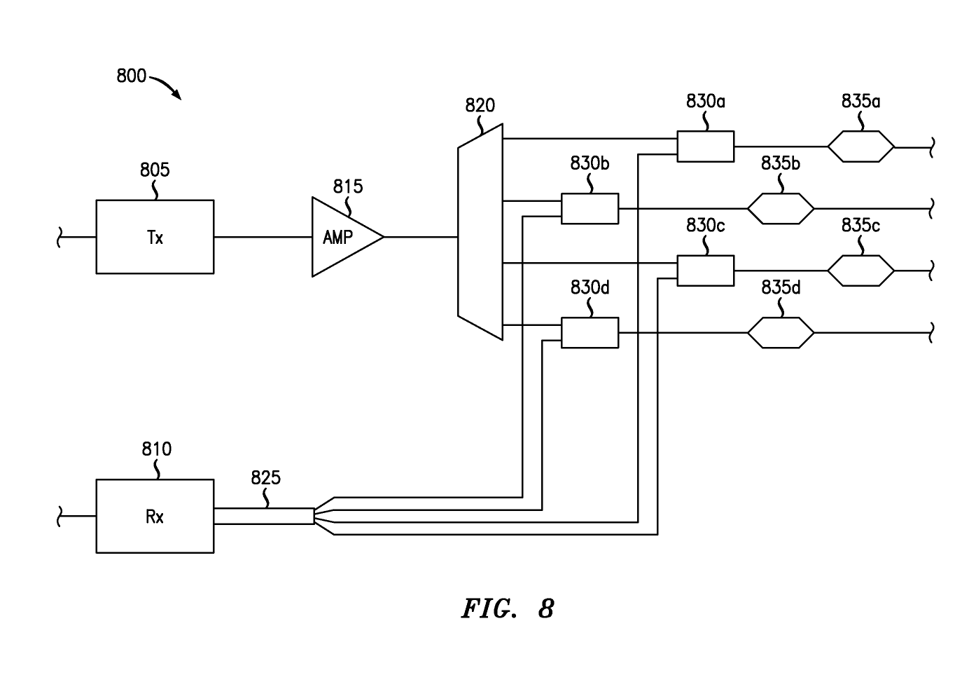

FIG. 8 is a simplified schematic diagram illustrating selected components of a protection OLT 800 according to an embodiment of the present invention. As alluded to above, an OLT such as OLT 800 will usually but not necessarily reside in a chassis or similar enclosure in a CO. In accordance with this embodiment, OLT 800 includes an optical transmitter (Tx) 805 and an optical receiver (Rx) 810. The transmitter 805 is for generating downstream transmissions (essentially replicates the other optical transmitters in the primary OLTs) and is typically connected to a network or network card (not shown in FIG. 8) from which it receives content and perhaps instructions on what to transmit. Similarly, receiver 810 is for receiving upstream transmissions.

OLT 800 is here referred to as a protection OLT and can be advantageously implemented, for example with the switch array 600 of FIG. 6 or the PON 700 of FIG. 7. In the embodiment shown in FIG. 8, there are four optical channels, corresponding to the four optical switches in switch array 705), although the number of optical channels provided in the OLT may vary according to the needs of a given implementation. It should be noted that although suited for use as a protection OLT in PON 700, OLT 800 would also be suited for functioning as a primary OLT if needed.

In this embodiment, an amplifier 815 is provided to amplify the output of the transmitter 805 and boost the optical power before the splitter 820. In a preferred embodiment, the amplifier is an SOA, although other forms of amplification may be used as well. A power splitter 820 distributes the amplified signal to the four communication channels. As mentioned above, however, in some PON implementations a feeder fiber may be in communication with the protection OLT when the switches of the switch array are in a normal operating configuration with the downstream traffic expected from a primary OLT.

For this reason, in the embodiment of FIG. 8 each optical channel downstream of the splitter 820 is provided with a respective VOA 835a, 835b, 835c, 835d. Each VOA is operated in such a manner as to permit a light beam from splitter 820 to pass only to a desired optical switch, for example in the arrays 305, 505, or 705 (respectively shown in FIGS. 3, 5, and 7). All other downstream transmissions are effectively blocked. Note that VOA operation will in most implementations affect upstream traffic as well. (In another embodiment (not shown), the VOAs may be placed upstream of the filters.) Note also that other attenuators or optical fiber shutters are considered equivalent to the VOA.

In this embodiment, each of the optical channels is also provided with an optical filter 830a, 830b, 830c, 830d to separate the upstream from the downstream data flows. Typically, in PONs different wavelengths are used for upstream as opposed to downstream traffic, so that the filters 830a, 830b, 830c, 830d selectively permit light of from the splitter 820 to downstream traffic to pass to pass to the switches of a switch array (subject to operation of the VOAs) while diverting any received upstream traffic to combiner 825 before being provided to receiver 810. The filters are for example dichroic filters or optical circulators. As the name implies, combiner 825 collects the signals from the (in this embodiment four) optical channels and provides a single input to the receiver 810. In a preferred embodiment, combiner 825 is a lossless multi-mode combiner that may be integrated with the other optical elements on the same optical chip.

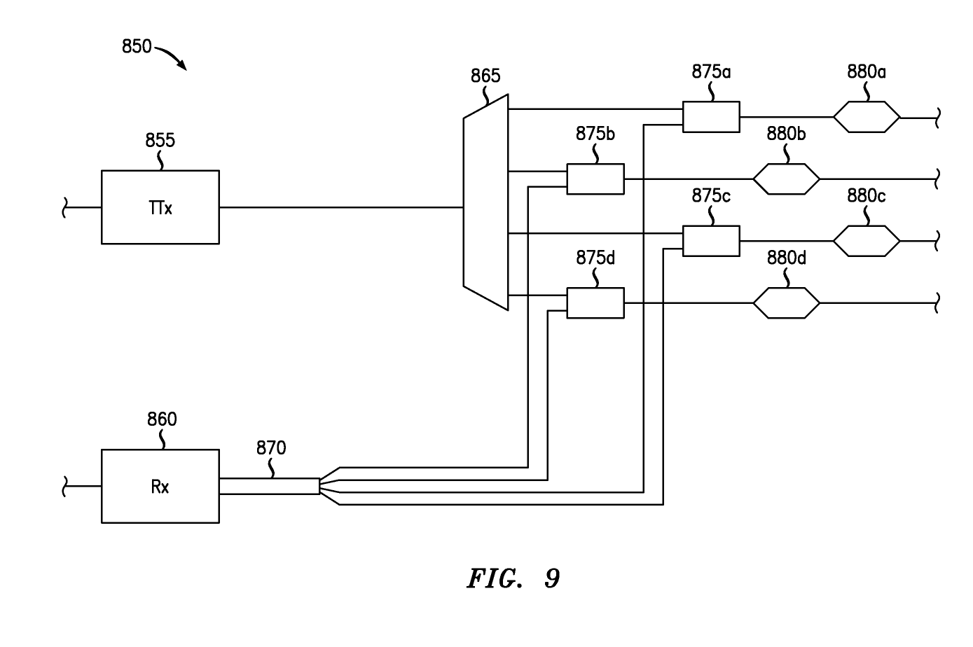

FIG. 9 is a simplified schematic diagram illustrating selected components of a OLT 850 according to another embodiment of the present invention. In this embodiment, four optical channels are present, although there could be any number within practical limitations. Transmissions along each of the channels may be controlled by a respective VOA 880a, 880b, 880c, 880d. Optical filters 875a, 875b, 875c, 875d allow downstream traffic to pass to a protection switch array (not shown), subject to the control of the VOAs, while upstream traffic is deflected to combiner 870 and then to receiver 860.

In accord with this embodiment of the present invention, a tunable transmitter (TTx) 855 is used to form downstream transmissions at varying wavelengths. A 1:4 demultiplexer (demux) 865, for example a wavelength selective filter such as an AWG, distributes each wavelength to the appropriate optical channel for downstream transmission to the switch array. In this combination the losses may be substantially less (as compared with the embodiment of FIG. 8), so no amplifier has been placed between the transmitter 855 and the demultiplexer 865 although its absence (or presence) is not a requirement unless explicitly recited. Naturally, the wavelengths used for downstream transmission are selected so as to permit proper operation of the optical filters 875a, 875b, 875c, 875d.

Many of the components described above may be formed on a single optical chip, for example a PLC (sometimes referred to as a PIC). The PLC may be based upon silica, silicon, other semiconductor compounds such as III-V materials, or polymeric compounds. In one preferred embodiment, the protection switch array is formed on a single optical chip along with the communication channels (including the VOAs and filters) and whatever means is used to distribute light from the transmitter to the communication channels (such as a power splitter or AWG).

Note that when an element is herein referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Note also that when in a particular embodiment a component is recited to have, for example, a “first” and “second” port or switch, and so on, that the terms such as “first” and “second” differentiate between the recited items and do not imply a part so labeled or ordered unless explicitly recited or evident from the context.

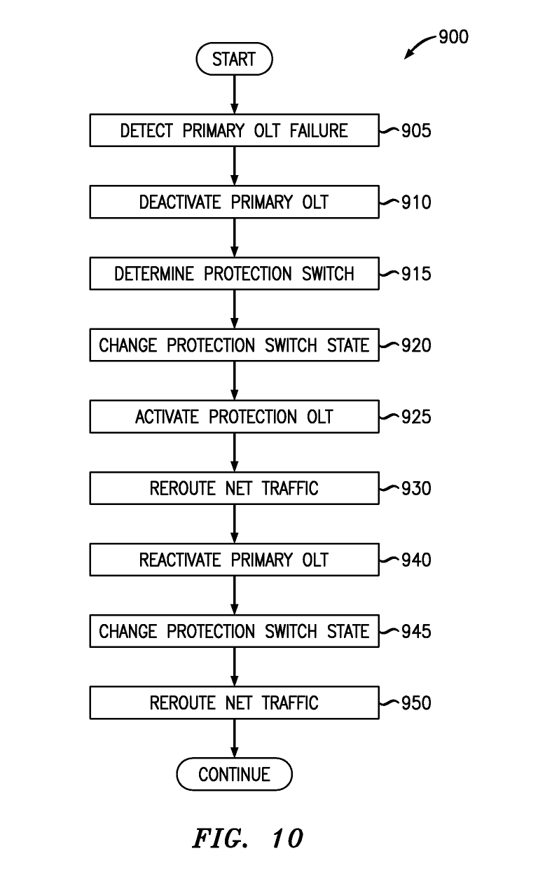

FIG. 10 is a flow diagram illustrating a method 900 of providing PON protection according to an embodiment of the present invention. At START it is presumed that the necessary components are present and operational according to this embodiment. An exemplary PON configuration for this embodiment is illustrated in FIG. 3. The process then begins with the detection of an OLT failure (step 905) in a primary OLT. As mentioned above, this outage may be the result of a planned maintenance activity or the failure of a component. A failure may be detected, for example, by monitoring the performance of the primary OLTs or by a network operator reporting mechanism or by determining that an expected response from one of the ONUs served has not been received (not separately shown). Note that the failure may be a complete failure or a degradation of performance beneath an acceptable lever. Whatever mechanism is used, the transmitter of the failed OLT is then deactivated (step 910) if it is not already inoperative.

In this embodiment, when the OLT outage occurs, the switch of a PON protection switch array that is associated with the OLT is determined (step 915), for example by reference to a lookup table in a memory device accessible to a system controller, both of which are normally present in the CO. As used herein, “memory device” refers to a hardware device or a hardware device executing software instructions, and not to a transitory signal. Similarly, “controller” as used herein refers to a hardware device or a hardware device executing software instructions. In a preferred embodiment, the optical switches of the protection switch array are 2×2 switches.

In the embodiment of FIG. 10, the state of the switch determined to be associated with the failed OLT is then changed (step 920) such that a protection OLT is placed in communication with the feeder fiber associated with the primary OLT and the switch. The protection OLT is then activated (step 925) and core network traffic to and from the failed primary OLT is routed to and from the protection OLT (step 930).

Communication using the protection OLT in place of the failed OLT then takes place, as necessary, and the protection has been achieved. In this embodiment, when the failed primary OLT has been repaired, replaced, or determined operational (step 935), it may be reactivated (step 940) (if it has not already been activated as part of the repair process). Note that although not separately shown, any diagnostic testing of the reactivated OLT may be performed using the fourth port of the “last” switch on the switch array (that is, the switch (in this embodiment) for which the fourth port is not in communication with the third port of another switch in the switch array).

In this embodiment, the state of the switch associated with the failed (now repaired) primary OLT is then changed (step 945) so that the primary OLT is placed in communication with the feeder fiber associated with the switch and the ONUs the primary OLT normally serves. Network traffic is then rerouted (step 950) to from the protection OLT to the primary OLT. Note it is preferred in this embodiment that the switch array is returned to its “normal” operating configuration (all switches in their first state) because it does not permit more than one OLT to be protected at one time (absent some reconfiguration). In some embodiments, the controller keeps track (not shown) of the state of each switch in the protection switch array so that no other switch state is changed when the protection OLT is already in use.

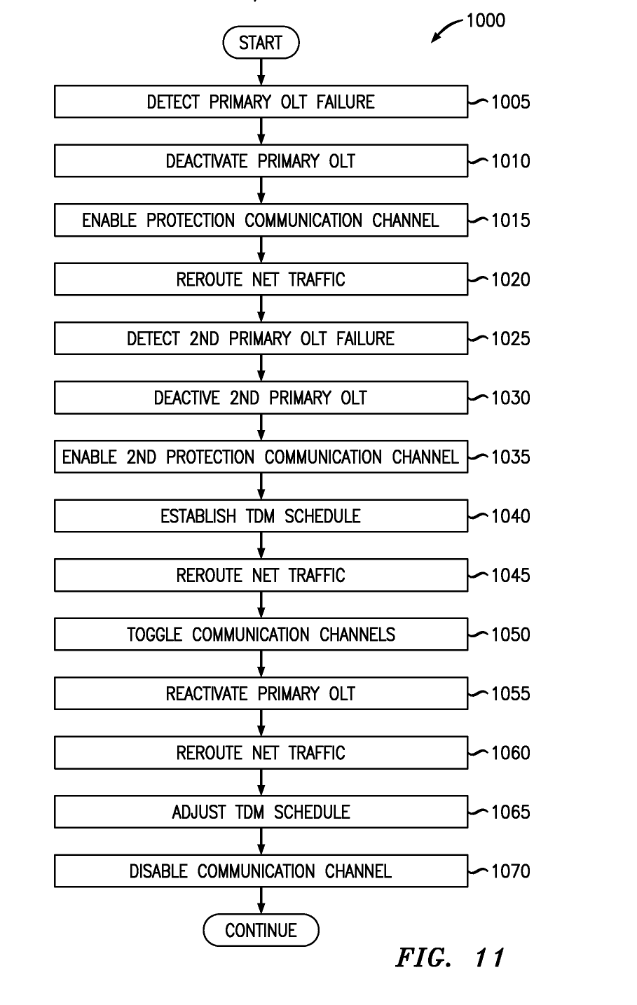

FIG. 11 is a flow diagram illustrating a method 1000 of providing PON protection according to another embodiment of the present invention. At START it is presumed that the necessary components are present and operational according to this embodiment. An exemplary configuration is illustrated in FIGS. 7 and 8. The process then begins with detecting (step 1005) the failure of a first primary OLT in a PON. As with the process described in reference to FIG. 10, this failure could be planned or unplanned, complete or simply an unacceptable degradation in service.

In the embodiment of FIG. 11, when failure is detected in a first primary OLT, the failed OLT is deactivated (step 1010). A communication channel from a protection OLT to a switch of a protection switch array that corresponds to the failed OLT is enabled (step 1015). In a preferred embodiment, this is performed by controlling a VOA in the communication channel (see, for example, VOA 835a depicted in FIG. 8). Naturally, in this case the VOA normally blocks the channel from being used. The PON communications to and from the failed primary OLT are then routed to the protection OLT (step 1020).

The process of method 1000 described above is similar though not identical to the relevant portion of method 900 illustrated in FIG. 10. But since method 1000 is associated with a different protection OLT/switch array configuration, the protection of an additional primary OLT may be obtained. An example of this is shown in FIG. 11.

In the embodiment of FIG. 11, a second primary OLT failure is detected (step 1025). Note that in referring to a first and second OLT failure in this embodiment implies that the second occurs before the first is remedied. When the second primary OLT failure is detected, the second primary OLT is deactivated (step 1030), and a communication channel from a protection OLT to a switch of a protection switch array that corresponds to the second failed OLT is enabled (step 1035).

In the embodiment of FIG. 11, a protection TDM schedule is then established (step 1040). The protection TDM schedule in essence divides the resources made available by the protection OLT between the two (or more, as applicable) communication channels. The division does not have to be equal, and may be based, for example, on historic traffic levels. In that case, it may be adjusted (not shown) as traffic levels change. The protection TDM schedule may be established, for example, by a system controller either on an ad hoc basis or according to a pre-determined schedule for the protection of two (or more) OLTs. The PON communications to and from the second failed primary OLT are then routed to the protection OLT (step 1045).

In this embodiment, the communication channels through which the protection of the two (or more) primary OLTs is being accomplished by the protection OLT are “toggled” (step 1050), or enabled and disabled according to the protection TDM schedule so that the appropriate communication channel is operative to place the protection OLT in communication with the access fibers with which it is currently transmitting to or receiving from. (Similar to normal operation in many PONs, the ONUs are notified of an upstream transmission schedule, which in this embodiment will take into account the sharing, if any, of the protection OLT.)

In the embodiment of FIG. 11, the protection configuration then continues until it is determined that a primary OLT that has failed has been repaired or replaced, it can then be activated (step 1055), if necessary, and the associated network traffic that is currently being routed through the protection OLT can now be routed through the primary OLT (step 1060). The TDM schedule is adjusted (step 1065) to account for the fact that the protection OLT is no longer handling traffic rerouted back to the reactivated primary OLT, or eliminated entirely. Finally, the communication channel between the protection OLT and the switch associated with the reactivated OLT is disabled (step 1070).

It is noted that the in the embodiment of FIG. 11, no change in protection switch state is necessary in association with rerouting of traffic to the protection OLT. This is possible, of course, because it was presumed a second feeder fiber was present for each switch, and the rerouted traffic simply uses the redundant feeder fiber. In other embodiments (not shown), it may be desirable to change the state of the associated protection switch to continue using the same feeder fiber as was being used by the failed primary OLT. And of course a switch state change is performed if the need to use a different feeder fiber due to a fiber failure.

It is further noted that the sequences of operation illustrated in FIGS. 10 and 11 represent exemplary embodiments; some variation is possible within the spirit of the invention. For example, additional operations may be added to those shown in FIGS. 10 and 11, and in some implementations one or more of the illustrated operations may be omitted. In addition, the operations of the method may be performed in any logically-consistent order unless a definite sequence is recited in a particular embodiment.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A protection system for a PON (passive optical network) comprising a plurality of switches, each switch of the plurality of switches having at least a first state and a second state and comprising a first port for communicating with a primary OLT (optical line terminal) and a second port for communicating via a feeder fiber, wherein the first port is placed in communication with the second port when a switch is in a first state.

2. The protection system of claim 1, wherein the plurality of switches comprises a plurality of 2×2 optical switches.

3. The protection system of claim 1, wherein each switch of the plurality of switches comprises a third port for communicating with a protection OLT wherein the third port is placed in communication with the second port when a switch is in a second state.

4. The protection system of claim 3, further comprising a plurality of primary OLTs.

5. The protection system of claim 3, further comprising at least one protection OLT.

6. The protection system of claim 5, wherein at least one switch of the array of switches communicates with the at least one protection OLT via at least one other switch of the plurality of switches.

7. The protection system of claim 6, wherein the at least one other switch comprises a fourth port in communication with the third port of the at least one switch.

8. The protection system of claim 5, wherein the communication channel between the third port of each switch of the plurality of switches and protection OLT does not include another switch of the plurality of switches.

9. The protection system of claim 8, wherein each switch of the plurality of switches further comprises a fourth port for communicating via a second feeder fiber wherein the first port is placed in communication with the fourth port when a switch is in the second state.

10. The protection system of claim 9, further comprising a plurality of first feeder fibers, each first feeder fiber connected to a second port of a respective switch of the plurality of switches.

11. The protection system of claim 9, further comprising a plurality of second feeder fibers, each second feeder fiber connected to a fourth port of a respective switch of the plurality of switches.

12. The protection system of claim 5, wherein the at least one protection OLT comprises an optical transmitter and means for distributing light from the transmitter to a plurality of communication channels, each communication channel associated with a switch of the plurality of switches.

13. The protection system of claim 12, wherein the means for distributing is a power splitter.

14. The protection system of claim 12, wherein the means for distributing is a wavelength selective filter.

15. The protection system of claim 14, wherein the wavelength selective filter is an AWG.

16. The protection system of claim 12, further comprising an optical amplifier situated on a communication channel between the optical transmitter and the means for distributing light.

17. The protection system of claim 12, further comprising a plurality of attenuators, each attenuator situated in a respective communication channel of the plurality of communication channels.

18. The protection system of claim 12, further comprising a plurality of shutters, each shutter situated in a respective communication channel of the plurality of communication channels.

19. The protection system of claim 5, wherein the plurality of switches are formed on a single optical chip.

20. The protection system of claim 19, wherein the single optical chip is a PLC.

21. The protection system of claim 19, wherein the protection OLT comprises a plurality of communication channels over which light passing through a means for distributing light propagates to respective switches of the plurality of switches, each communication channel comprising a VOA, and wherein the means for distributing light and the plurality of communication channels are formed on the single optical chip.
